(19) United States
(12) Patent Application Publication
(10) Pub. No.: US 2020/0239745 A1
(43) Pub. Date: Jul. 30, 2020

(54) SEALANT AND ITS PREPARATION METHOD, DISPLAY PANEL AND DISPLAY DEVICE

(71) Applicant: BOE TECHNOLOGY GROUP CO., LTD., Beijing (CN)

(72) Inventors: Le GUO, Beijing (CN); Ran ZHANG, Beijing (CN); Hengzhen LIANG, Beijing (CN); Hui DONG, Beijing (CN); Chao LV, Beijing (CN); Xinwei JIAO, Beijing (CN)

(21) Appl. No.: 15/768,506

(22) PCT Filed: Sep. 30, 2017
(86) PCT No.: PCT/CN2017/104715

§ 371 Date: Apr. 13, 2018

(30) Foreign Application Priority Data
Mar. 29, 2017 (CN) 201710199003.6

(51) Int. Cl. C09J 11/04; C09J 163/00; G02F 1/1339

(52) U.S. Cl. CPC C09J 11/04; G02F 1/1339; C09J 163/00

(57) ABSTRACT

Some embodiments of the present disclosure relate to a sealant and its preparation method, a display panel and a display device. The sealant according to some embodiments of the present disclosure includes a sealant base component and also an amine-modified nanomaterial.

### CROSS-REFERENCE TO RELATED APPLICATIONS

This application is a U.S. National Stage under 35 U.S.C. § 371 of International Patent Application No. PCT/CN2017/104715, filed on Sep. 30, 2017, which claims priority to Chinese Patent Application No. 201710199003.6, filed on Mar. 29, 2017, the contents of which are incorporated herein by reference in their entirety for all purposes.

### TECHNICAL FIELD

The present disclosure relates to a sealant and its preparation method, a display panel and a display device.

### BACKGROUND

The main component of a conventional sealant is epoxy resin. Since epoxy resin itself is a poor conductor of heat, with a slow heat transfer rate, it results in a large temperature gradient of the sealant from outside to inside.

### SUMMARY

Some embodiments of the present disclosure provide a sealant and its preparation method, a display panel and a display device.

According to one aspect of the present disclosure, a sealant is provided, comprising a sealant base component and further comprising an amine-modified nanomaterial.

In some embodiments, the nanomaterial includes at least one of multi-walled carbon nanotubes, graphene, graphite, boron nitride, aluminum nitride, silicon nitride, silicon carbide. In some embodiments, the nanomaterial includes multi-walled carbon nanotubes.

In some embodiments, the sealant base component includes epoxy resin or modified epoxy resin; and may further include acrylate, phenolic resin. Among them, epoxy resin or modified epoxy resin is necessary, and acrylate and phenol resin are optional.

In the sealant according to some embodiments of the present disclosure, the sealant base component may be commercially available, for example, a sealant comprising epoxy resin and acrylate as main components, a sealant comprising acrylate-modified epoxy resin (such as epoxy acrylate), a sealant comprising epoxy resin and phenolic resin as main components and so on.

Alternatively, the sealant comprises, by mass fraction, from 95% to 99.9% of the sealant base component and from 0.1% to 5% of the amine-modified nanomaterial; in some embodiments, the sealant comprises from 97% to 99.5% of the sealant base component and from 0.5% to 3% of the amine-modified nanomaterial.

When the amount of the amine-modified nanomaterial is less than 0.1%, the nanomaterial is encapsulated by the sealant base component, and the effect of thermal conduction is weaker; when the amount of the amine-modified nanomaterial is more than 5%, the nanomaterial is difficult to be uniformly dispersed, and is easily aggregated due to high van der Waals force, thereby impairing the mechanical properties of the sealant.

In the amine-modified nanomaterial according to some embodiments of the present disclosure, the amine includes aliphatic amines or aromatic amines. The aliphatic amine may be a C1 to C12 amine such as methylamine, ethylamine, methylethylamine, dimethylamine, diethylamine, isopropylamine, tert-butylamine, pentylamine, hexylamine, heptylamine, octylamine, ethylenediamine, 1,3-propanediamine, 1,4-butanediamine, 1,5-pentanediamine, diethylenetriamine and the like; the aromatic amine may be such as benzylamine, phenethylamine, amphetamine and the like. With a consideration of having more cross-linking sites, the amine according to some embodiments of the present disclosure may be diamines and triamines. It should be emphasized that, since the amine according to some embodiments of the present disclosure is to be cross-linked with the sealant base component, it can be primary amines or secondary amines.

In some embodiments, the amine is N-(2-aminoethyl)-1,2-ethylenediamine (DETA).

In some embodiments, the amine modified nanomaterial according to some embodiments of the present disclosure is N-(2-aminoethyl)-1,2-ethylenediamine (DETA) modified multi-walled carbon nanotubes.

Alternatively, in the amine-modified nanomaterial, the mass fraction of amine is from 3% to 8%. In some embodiments of the present disclosure, the mass fraction of amine is calculated as follows: the added mass of the final modified nanomaterial product, which is the mass of amine, relative to the initial nanomaterial is analyzed according to a TG curve; the ratio of the mass of amine to the mass of the modified nanomaterial product is the mass fraction of amine.

According to another aspect of the present disclosure, a method for preparing a sealant is provided, comprising: mixing an amine-modified nanomaterial with a sealant base component, followed by defoaming and curing, to obtain the sealant.

The method can be implemented, for example, by mixing an amine-modified nanomaterial with a sealant base component, sonicating and then stirring at 500 to 1000 rpm for 1 to 5 hours to obtain a homogeneous mixture, followed by the addition of a defoaming agent to remove bubbles at 50 to 70° C. under vacuum; and, after complete removal of bubbles, curing the mixture to give the final product sealant.

Alternatively, the curing includes: precuring at 80° C. for 2 h, curing at 100° C. and 140° C. for 3 h and 4 h respectively, and then post-curing in a vacuum oven at 150° C. for 30 min. After post-curing, a viscous sealant is obtained, which is favorable for demoulding and subsequent coating.

The amine-modified nanomaterial can be obtained, for example, by:

Mixing a nanomaterial with a concentrated acid, sonicating for 10-20 min to prevent clusters, and heating in a water bath at 50-80° C. for 8-12 h to generate a large amount of carboxyl groups and hydroxyl groups, thereby obtaining an acid-treated nanomaterial; then, heating the acid-treated nanomaterial with a small amount of SOCl₂ in a water bath at 50-80° C. for 18-30 h, filtering, drying, and then heating with an amine in a water bath at 100-150° C. for 30-40 h, and thereafter drying in a vacuum oven at 50-70° C. for 40-60 h, to obtain the amine-modified nanomaterial.

Alternatively, the concentrated acid is selected from one or more (in some embodiments two or more) of H₂SO₄, HNO₃, HCl, HBr, HI and HClO₄.

Alternatively, the mass ratio of nanomaterial, SOCl₂ and amine is (75-90):(1-2):(3-8).

According to another aspect of the present disclosure, a display panel is provided, including the sealant as described above.

The display panel according to some embodiments of the present disclosure may be prepared by a method commonly used in the art, which, for example, may comprise:

(1) applying a sealant composition according to some embodiments of the present disclosure to an edge of an upper glass substrate and/or a lower glass substrate;

(2) box-aligning the upper glass substrate and the lower glass substrate.

According to another aspect of the present disclosure, a display device is provided, including the display panel as described above.

### BRIEF DESCRIPTION OF THE DRAWINGS

FIG. 1 is a structural schematic diagram of an interface bonding layer between a DETA modified multi-walled carbon nanotube and a sealant according to some embodiments of the present disclosure;

FIG. 2 shows TGA curves of sealants with different amounts of multi-walled carbon nanotubes;

FIG. 3 shows impact resistance curves of sealants with different amounts of multi-walled carbon nanotubes;

FIG. 4 shows coefficient of thermal conductivity curves of sealants with different amounts of multi-walled carbon nanotubes;

FIG. 5 is a schematic diagram of a method for applying a sealant according to some embodiments of the present disclosure;

FIG. 6 is a package structure diagram of a sealant according to some embodiments of the present disclosure.

### DETAILED DESCRIPTION

The detailed description of the disclosure is for describing some embodiments of the present disclosure, but not for limiting the contents of some embodiments of the present disclosure. Some embodiments of the present disclosure will be further illustrated and described below with reference to the detailed description of the disclosure.

Conventional sealants have at least the following problems: uneven curing, incomplete curing, which thus easily result in contaminants to contaminate liquid crystal, afterimage and the like. In addition, conventional sealants also have the problems of insufficient hardness and insufficient thermal stability. The former leads to the problems of sealant breakage and liquid crystal leakage during transport and quality assessment, which seriously affects stability of sealant-encapsulated structures. The latter leads to: a. during high temperature curing process of sealants, gasified small molecules enter into liquid crystal to affect the liquid crystal's purity; b. poor fitting or dislocation of sealant, thereby causing liquid crystal leakage and disordered alignment state, and finally resulting in poor display.

Some embodiments of the present disclosure provide a sealant and its preparation method, a display panel and a display device, so as to solve the problems associated with conventional sealants including poor thermal conductivity, insufficient hardness and poor thermal stability.

According to one aspect of the present disclosure, a sealant is provided, comprising a sealant base component and further comprising an amine-modified nanomaterial.

Alternatively, the nanomaterial includes at least one of multi-walled carbon nanotubes, graphene, graphite, boron nitride, aluminum nitride, silicon nitride, silicon carbide. In some embodiments, the nanomaterial includes multi-walled carbon nanotubes.

The sealant base component includes epoxy resin or modified epoxy resin; and may further include acrylate, phenolic resin. Among them, epoxy resin or modified epoxy resin is necessary, and acrylate and phenol resin are optional.

In the sealant according to some embodiments of the present disclosure, the sealant base component may be commercially available, for example, a sealant comprising epoxy resin and acrylate as main components, a sealant comprising acrylate-modified epoxy resin (such as epoxy acrylate), a sealant comprising epoxy resin and phenolic resin as main components and so on, such as UR-2920 sealant (which is manufactured by Mitsui Chemicals Co., Ltd., and the main components of which are epoxy resin and acrylate), 9-20737 sealant (which is manufactured by Dymax, and the main components of which are epoxy acrylate, polyurethane acrylate, etc.) and so on.

Alternatively, the sealant comprises, by mass fraction, from 95% to 99.9% of the sealant base component and from 0.1% to 5% of the amine-modified nanomaterial; in some embodiments, the sealant comprises from 97% to 99.5% of the sealant base component and from 0.5% to 3% of the amine-modified nanomaterial.

When the amount of the amine-modified nanomaterial is less than 0.1%, the nanomaterial is encapsulated by the sealant base component, and the effect of thermal conduction is weak; when the amount of the amine-modified nanomaterial is more than 5%, the nanomaterial is difficult to be uniformly dispersed, and is easily aggregated due to high van der Waals force, thereby impairing the mechanical properties of the sealant.

In the amine-modified nanomaterial according to some embodiments of the present disclosure, the amine includes aliphatic amines or aromatic amines. The aliphatic amine may be a C1 to C12 amine such as methylamine, ethylamine, methylethylamine, dimethylamine, diethylamine, isopropylamine, tert-butylamine, pentylamine, hexylamine, heptylamine, octylamine, ethylenediamine, 1,3-propanediamine, 1,4-butanediamine, 1,5-pentanediamine, diethylenetriamine and the like; the aromatic amine may be such as benzylamine, phenethylamine, amphetamine and the like. With a consideration of having more cross-linking sites, the amine according to some embodiments of the present disclosure may be diamines and triamines. It should be emphasized that, since the amine according to some embodiments of the present disclosure is to be cross-linked with the sealant base component, it can be primary amines or secondary amines.

In some embodiments, the amine is N-(2-aminoethyl)-1,2-ethylenediamine (DETA).

In some embodiments, the amine modified nanomaterial according to some embodiments of the present disclosure is N-(2-aminoethyl)-1,2-ethylenediamine (DETA) modified multi-walled carbon nanotubes.

Alternatively, in the amine-modified nanomaterial, the mass fraction of amine is from 3% to 8%. In some embodiments of the present disclosure, the mass fraction of amine is calculated as follows: the added mass of the final modified nanomaterial product, which is the mass of amine, relative to the initial nanomaterial is analyzed according to a TG curve; the ratio of the mass of amine to the mass of the modified nanomaterial product is the mass fraction of amine.

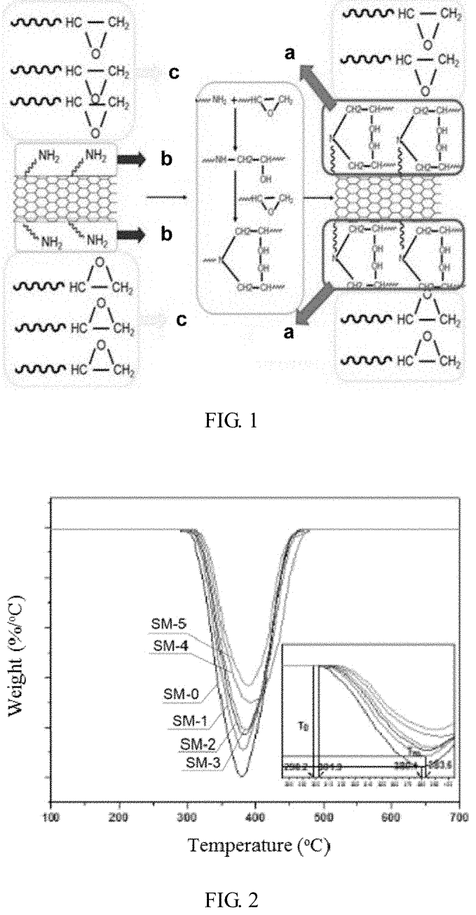

FIG. 1 is a structural schematic diagram of an interface bonding layer between a DETA modified multi-walled carbon nanotube and a sealant according to some embodiments of the present disclosure. Since the multi-walled carbon nanotubes and the sealant base component are respectively inorganic material and organic material, there is a poor crosslinking between them. After the multi-walled carbon nanotubes are modified by DETA (as shown in FIG. 1, b), amino group (—NH₂) of DETA can crosslink with epoxy group in the sealant base component (as shown in FIG. 1, c) to form a “core-shell” interface crosslinked layer (where “core” is multi-walled carbon nanotubes, “shell” is a crosslinked structure formed by DETA and epoxy group in the sealant base component (as shown in FIG. 1, a)), which results in an increased interface compatibility between the multi-walled carbon nanotubes and the sealant base component (epoxy resin), thereby improving the mechanical properties and bond strength of the sealant, and enhancing the effect of the sealant coating process.

According to another aspect of the present disclosure, a method for preparing a sealant is provided, comprising: mixing an amine-modified nanomaterial with a sealant base component, followed by defoaming and curing, to obtain the sealant.

The method can be implemented, for example, by mixing an amine-modified nanomaterial with a sealant base component, sonicating and then stirring at 500 to 1000 rpm for 1 to 5 hours to obtain a homogeneous mixture, followed by the addition of a defoaming agent to remove bubbles at 50 to 70° C. under vacuum; and, after complete removal of bubbles, curing the mixture to give the final product sealant.

Wherein, the defoaming agent may be polyether-modified silicones, polyethers and polysiloxanes such as polyoxyethylene polyoxypropylene pentaerythritol ether, polyoxyethylene polyoxypropanol amine ether, polyoxypropylene glyceryl ether and polyoxypropylene polyoxyethylene glyceryl ether, polydimethylsiloxane and the like.

The stirring may be manual stirring or mechanical stirring; in some embodiments the stirring may be mechanical stirring, for example, with a strong stirrer.

The curing includes: precuring at 80° C. for 2 h, curing at 100° C. and 140° C. for 3 h and 4 h, respectively, and post-curing in a vacuum oven at 150° C. for 30 min. After post-curing, a viscous sealant is obtained, which is favorable for demoulding and subsequent coating.

The amine-modified nanomaterial can be obtained, for example, by:

Mixing a nanomaterial with a concentrated acid, sonicating for 10-20 min to prevent clusters, and heating in a water bath at 50-80° C. for 8-12 h to generate a large amount of carboxyl groups and hydroxyl groups, thereby obtaining an acid-treated nanomaterial; then, heating the acid-treated nanomaterial with a small amount of SOCl₂ in a water bath at 50-80° C. for 18-30 h, filtering, drying, then heating with an amine in a water bath at 100-150° C. for 30-40 h, and thereafter drying in a vacuum oven at 50-70° C. for 40-60 h, to obtain the amine-modified nanomaterial.

Alternatively, the concentrated acid is selected from one or more (in some embodiments two or more) of H₂SO₄, HNO₃, HCl, HBr, HI and HClO₄. For example, the concentrated acid may be a mixed solution of H₂SO₄ (98 wt %) and HNO₃ (65 wt %) in a volume ratio of 3:1, and the concentrated acid may be a mixed solution of H₂SO₄ (98 wt %) and HCl (37 wt %) in a volume ratio of 2:1 and so on. During the modification of nanomaterial, not all of the acid can react with the nanomaterial, so the amount of concentrated acid used in the modification is excessive.

Alternatively, the mass ratio of nanomaterial, SOCl₂ and amine is (75-90):(1-2):(3-8).

According to another aspect of the present disclosure, a display panel is provided, including the sealant as described above.

Wherein, the method for applying the sealant according to some embodiments of the present disclosure is as shown in FIG. 5. Under the action of N₂ gas pressure 1, a viscous sealant 2 is sprayed onto a CF substrate through a nozzle 3, and simultaneously a machine 4 moves at a speed of 10 m/min to complete coating of the CF substrate.

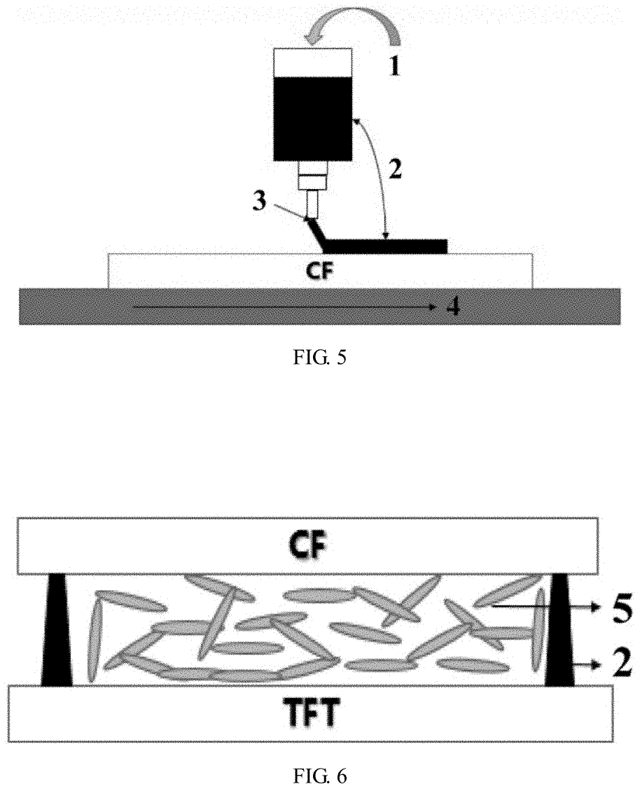

The sealant according to some embodiments of the present disclosure has a package structure as shown in FIG. 6. A viscous sealant 2 is coated according to the coating method as shown in FIG. 5, the coated sealant 2 is cured (after UV curing, hot curing at 130° C. for about 10 min) to form a solid sealant to fix a TFT substrate and a LCD substrate, and package a liquid crystal 5 in the panel, while controlling a gap around the panel in favor of cutting off and conduction effect of Au conductive ball.

A liquid crystal panel according to some embodiments of the present disclosure may be prepared by a method commonly used in the art, which, for example, may comprise:

(1) applying a sealant composition according to some embodiments of the present disclosure to an edge of an upper glass substrate and/or a lower glass substrate;

(2) box-aligning the upper glass substrate and the lower glass substrate.

According to another aspect of the present disclosure, a display device is provided, including the display panel as described above.

For having excellent thermal conductivity and an increased coefficient of thermal conductivity, the nanomaterial in the sealant according to some embodiments of the present disclosure is heated uniformly and sufficiently from outside to inside during hot curing, and is cured completely, so that the production efficiency is increased, and meanwhile the problems including contamination of the liquid crystal material caused by uneven curing of the sealant, as well as low working efficiency, short service life and the like due to too high local temperatures can be avoided.

For having a nanoscale size, the nanomaterial in the sealant according to some embodiments of the present disclosure can absorb external energy, and thereby improve mechanical properties of the sealant material. When the nanomaterial is modified by an amine, amine-based molecular chains on its surface can participate in the curing process of epoxy resin, and form a dense crosslinked layer by chemical reaction with epoxy groups, which greatly improves compatibility with epoxy groups of the epoxy resin, and transfers load and energy, thereby further improving the mechanical properties of the sealant material, and avoiding the problems including sealant breakage, liquid crystal leakage and the like because of destroyed product packaging structure, which is resulted when liquid crystal products (especially large-size liquid crystal products) are subjected to an external impact during transport and movement.

The nanomaterial in the sealant according to some embodiments of the present disclosure has excellent heat resistance, so it improves the thermal stability of the sealant material, and avoids the following problems: during high temperature curing process of the sealant, gasified small molecules entering into liquid crystal to affect the liquid crystal's purity; and liquid crystal leakage and disordered alignment state due to poor fitting or dislocation of sealant.

One or more embodiments of the present disclosure will be described in detail below by way of examples.

### Example 1

(1) 84 g of multi-walled carbon nanotubes and 100 mL of concentrated acid (H₂SO₄/HNO₃ in a volume ratio of 3:1, wherein the concentration of H₂SO₄ was 98 wt %, the concentration of HNO₃ was 65 wt %) were sonicated for 15 min to prevent clusters, and heated in a water bath at 60° C. for 10 h to generate a large amount of carboxyl groups and hydroxyl groups; thereafter, the multi-walled carbon nanotubes and 1 g of SOCl₂ were heated in a water bath at 70° C. for 24 h, filtered and dried, and then heated with 5 g of N-(2-aminoethyl)-1,2-ethylenediamine in a water bath at 120° C. for 36 h, and dried in a vacuum oven at 60° C. for 48 h, to obtain modified multi-walled carbon nanotubes.

(2) 0.7 g of the modified multi-walled carbon nanotubes and 99.3 g of a sealant resin (9-20737 sealant) were mixed, sonicated and stirred with a strong stirrer at 700 rpm for 2 h to obtain a homogeneous mixture, followed by the addition of polyoxyethylene polyoxypropylene pentaerythritol ether as a defoaming agent, to remove bubbles at 60° C. under vacuum. After complete removal of bubbles, the mixture was injected into a required mold, to perform pre-curing at 80° C. for 2 h, curing at 100° C. and 140° C. for 3 h and 4 h respectively, and then curing in a vacuum oven at 150° C. for 30 min, to obtain the final product sealant.

### Example 2

This example was the same as Example 1 except for that, in the step (2), the amount of the modified multi-walled carbon nanotubes was 1 g, and the amount of the sealant resin was 99 g.

### Example 3

This example was the same as Example 1 except for that, in the step (2), the amount of the modified multi-walled carbon nanotubes was 2 g, and the amount of the sealant resin was 98 g.

### Example 4

This example was the same as Example 1 except for that, in the step (2), the amount of the modified multi-walled carbon nanotubes was 3 g, and the amount of the sealant resin was 97 g.

### Example 5

This example was the same as Example 1 except for that, in the step (2), the amount of the modified multi-walled carbon nanotubes was 4 g, and the amount of the sealant resin was 96 g.

### Example 6

This example was the same as Example 1 except for that, in the step (2), the amount of the modified multi-walled carbon nanotubes was 5 g, and the amount of the sealant resin was 95 g.

### Example 7

0.7 g of unmodified multi-walled carbon nanotubes and 99.3 g of a sealant resin (9-20737 sealant) were mixed, sonicated and then stirred with a strong stirrer at 700 rpm for 2 h to obtain a homogeneous mixture, followed by the addition of polyoxyethylene polyoxypropylene pentaerythritol ether as a defoaming agent, to remove bubbles at 60° C. under vacuum. After complete removal of bubbles, the mixture was injected into a required mold, to perform pre-curing at 80° C. for 2 h, curing at 100° C. and 140° C. for 3 h and 4 h respectively, and then curing in a vacuum oven at 150° C. for 30 min, to obtain the final product sealant.

### Example 8

This example was the same as Example 7 except for that, in the step (2), the amount of the modified multi-walled carbon nanotubes was 1 g, and the amount of the sealant resin was 99 g.

### Example 9

This example was the same as Example 7 except for that, in the step (2), the amount of the modified multi-walled carbon nanotubes was 2 g, and the amount of the sealant resin was 98 g.

### Example 10

This example was the same as Example 7 except for that, in the step (2), the amount of the modified multi-walled carbon nanotubes was 3 g, and the amount of the sealant resin was 97 g.

### Example 11

This example was the same as Example 7 except for that, in the step (2), the amount of the modified multi-walled carbon nanotubes was 4 g, and the amount of the sealant resin was 96 g.

### Example 12

This example was the same as Example 7 except for that, in the step (2), the amount of the modified multi-walled carbon nanotubes was 5 g, and the amount of the sealant resin was 95 g.

### Example 13

(1) 75 g of graphene and 100 mL of concentrated acid (H₂SO₄/HCl in a volume ratio of 2:1, wherein the concentration of H₂SO₄ was 98 wt %, the concentration of HCl was 37 wt %) were sonicated for 15 min to prevent clusters, and heated in a water bath at 70° C. for 8 h to generate a large amount of carboxyl groups and hydroxyl groups; thereafter, the graphene and 1.2 g of SOCl₂ were heated in a water bath at 75° C. for 20 h, filtered and dried, and then heated with 3 g of N-(2-aminoethyl)-1,2-ethylenediamine in a water bath at 105° C. for 40 h, and dried in a vacuum oven at 65° C. for 40 h, to obtain a modified graphene.

(2) 0.7 g of the modified graphene and 99.3 g of a sealant resin (UR-2920 sealant) were mixed, sonicated and stirred with a strong stirrer at 800 rpm for 3 h to obtain a homogeneous mixture, followed by the addition of polyoxyethylene polyoxypropylene pentaerythritol ether as a defoaming agent, to remove bubbles at 65° C. under vacuum. After complete removal of bubbles, the mixture was injected into a required mold, to perform pre-curing at 80° C. for 2 h, curing at 100° C. and 140° C. for 3 h and 4 h respectively, and then curing in a vacuum oven at 150° C. for 30 min, to obtain the final product sealant.

### Example 14

(1) 90 g of boron nitride and 105 mL of concentrated acid (H₂SO₄/HNO₃ in a volume ratio of 2:1, wherein the concentration of H₂SO₄ was 98 wt %, the concentration of HNO₃ was 65 wt %) were sonicated for 20 min to prevent clusters, and heated in a water bath at 50° C. for 30 h to generate a large amount of carboxyl groups and hydroxyl groups; thereafter, the boron nitride and 2 g of SOCl₂ were heated in a water bath at 60° C. for 30 h, filtered and dried, and then heated with 7 g of N-(2-aminoethyl)-1,2-ethylenediamine in a water bath at 100° C. for 36 h, and dried in a vacuum oven at 55° C. for 60 h, to obtain a modified boron nitride.

(2) 1 g of the modified boron nitride and 99 g of a sealant resin (9-20737 sealant) were mixed, sonicated and stirred with a strong stirrer at 600 rpm for 5 h to obtain a homogeneous mixture, followed by the addition of polyoxyethylene polyoxypropylene pentaerythritol ether as a defoaming agent, to remove bubbles at 65° C. under vacuum. After complete removal of bubbles, the mixture was injected into a required mold, to perform pre-curing at 80° C. for 2 h, curing at 100° C. and 140° C. for 3 h and 4 h respectively, and then curing in a vacuum oven at 150° C. for 30 min, to obtain the final product sealant.

### Example 15

(1) 80 g of silicon nitride and 90 mL of concentrated acid (HCl/HNO₃ in a volume ratio of 3:1, wherein the concentration of HCl was 37 wt %, the concentration of HNO₃ was 65 wt %) were sonicated for 10 min to prevent clusters, and heated in a water bath at 60° C. for 10 h to generate a large amount of carboxyl groups and hydroxyl groups; thereafter, the silicon nitride and 1.5 g of SOCl₂ were heated in a water bath at 70° C. for 24 h, filtered and dried, and then heated with 4 g of N-(2-aminoethyl)-1,2-ethylenediamine in a water bath at 120° C. for 36 h, and dried in a vacuum oven at 60° C. for 48 h, to obtain a modified silicon nitride.

(2) 2 g of the modified silicon nitride and 98 g of a sealant resin (UR-2920 sealant) were mixed, sonicated and stirred with a strong stirrer at 500 rpm for 5 h to obtain a homogeneous mixture, followed by the addition of polyoxyethylene polyoxypropylene pentaerythritol ether as a defoaming agent, to remove bubbles at 70° C. under vacuum. After complete removal of bubbles, the mixture was injected into a required mold, to perform pre-curing at 80° C. for 2 h, curing at 100° C. and 140° C. for 3 h and 4 h respectively, and then curing in a vacuum oven at 150° C. for 30 min, to obtain the final product sealant.

### Comparative Example

To 100 g of a sealant resin (9-20737 sealant), was added polyoxyethylene polyoxypropylene pentaerythritol ether as a defoaming agent, to remove bubbles at 60° C. under vacuum. After complete removal of bubbles, the mixture was injected into a required mold, to perform pre-curing at 80° C. for 2 h, curing at 100° C. and 140° C. for 3 h and 4 h respectively, and then curing in a vacuum oven at 150° C. for 30 min, to obtain a sealant.

Evaluation on Thermal Stability

With the addition of the multi-walled carbon nanotubes of Comparative example (SM-0), and Examples 2 to 6 (SM-1 to SM-5), the results of thermal stability of the sealants were as shown in FIG. 2. It could be seen that, with a continuous increase in the amount of the modified multi-walled carbon nanotubes, the TGA curves of the sealants continuously moved to high temperature regions. The temperature at which a material has a weight loss of 5% is generally regarded as its initial weight loss temperature T₀. When the amount of the multi-walled carbon nanotubes was 1 wt %, the T₀ increased from 298.2° C. to 301.9° C., and the maximum weight loss temperature increased from 380.4° C. to 383.6° C., which proved that the addition of the modified multi-walled carbon nanotubes was conducive to the thermal stability of the sealants at high temperatures.

Evaluation on Mechanical Properties

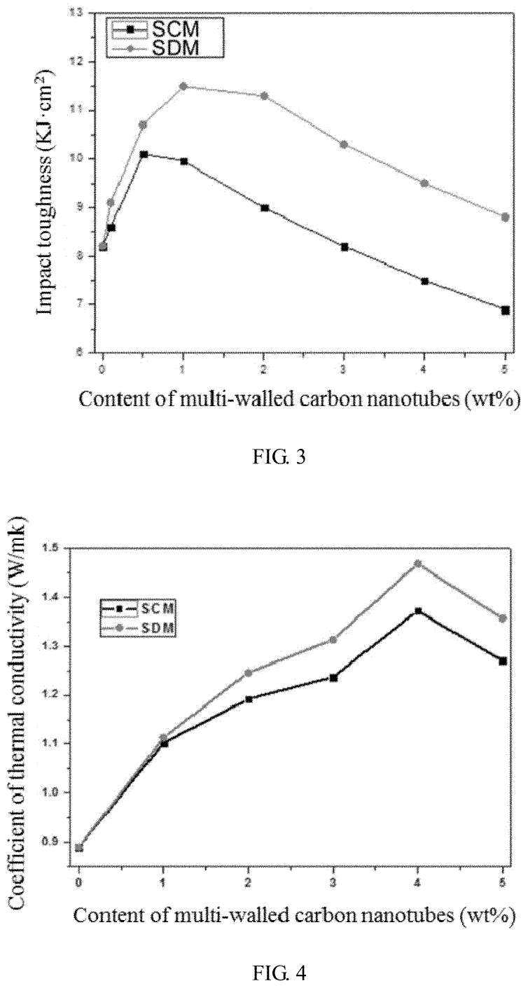

With the addition of the modified or unmodified multi-walled carbon nanotubes of Examples 1 to 12, the impact properties of the sealants were as shown in FIG. 3 (where SCM referred to unmodified multi-walled carbon nanotubes, SDM referred to modified multi-walled carbon nanotubes). With an increase in the amount of the multi-walled carbon nanotubes, the impact strength showed a trend of increasing first and then decreasing. This was due to that the multi-walled carbon nanotubes could absorb external energy because of their extremely high aspect ratio and nanoscale size, and thereby improve mechanical properties of the sealant material. When the amount of the multi-walled carbon nanotubes was 0.7 wt %, the impact strength could increase from 8.19 Kj/m² to 10.06 Kj/m². However, with a further increase in the amount of the multi-walled carbon nanotubes, the multi-walled carbon nanotubes were difficult to be uniformly dispersed, and were easily aggregated due to high van der Waals force, thereby impairing the mechanical properties of the sealant.

Compared with the unmodified multi-walled carbon nanotubes, when the multi-walled carbon nanotubes were modified by DETA, the DETA molecular chains on their surface could participate in the curing process of the sealant epoxy resin, and form a dense crosslinked layer by chemical reaction with epoxy groups (the model diagram was as shown in FIG. 1), which could greatly improve compatibility with epoxy groups of the epoxy resin, and transfer load and energy, thereby further improving the mechanical properties.

Evaluation on Thermal Conductivity

With the addition of the modified or unmodified multi-walled carbon nanotubes of Examples 2 to 6 and 8 to 12, the results of thermal conductivity of the sealants were as shown in FIG. 4 (where SCM referred to unmodified multi-walled carbon nanotubes, SDM referred to modified multi-walled carbon nanotubes). It could be seen that, with an increase in the amount of the multi-walled carbon nanotubes, the coefficient of thermal conductivity showed a trend of increasing first and then decreasing, and the optimal amount of the multi-walled carbon nanotubes to achieve the optimal coefficient of thermal conductivity was 4 wt %. Compared with the unmodified multi-walled carbon nanotubes, the modified multi-walled carbon nanotubes improved the thermal conductivity more significantly.

Those skilled in the art can make various modifications and variations to some embodiments of the present disclosure without departing from the spirit and scope of the disclosure. As such, some embodiments of the present disclosure are intended to comprise these modifications and variations provided that such modifications and variations fall within the scope of the following claims and their equivalents.

1. A sealant, comprising: a sealant base component; and an amine-modified nanomaterial.

2. The sealant according to claim 1, wherein the amine-modified nanomaterial includes at least one of multi-walled carbon nanotubes, graphene, graphite, boron nitride, aluminum nitride, silicon nitride, or silicon carbide.

3. The sealant according to claim 1, wherein the sealant base component includes an epoxy resin or modified epoxy resin.

4. The sealant according to claim 1, wherein the sealant comprises, by mass fraction, from 95% to 99.9% of the sealant base component and from 0.1% to 5% of the amine-modified nanomaterial.

5. The sealant according to claim 1, wherein the sealant comprises, by mass fraction, from 97% to 99.5% of the sealant base component and from 0.5% to 3% of the amine-modified nanomaterial.

6. The sealant according to claim 1, wherein an amine in the amine-modified nanomaterial includes aliphatic amines or aromatic amines.

7. The sealant according to claim 1, wherein an amine in the amine-modified nanomaterial includes N-(2-aminoethyl)-1,2-ethylenediamine.

8. The sealant according to claim 1, wherein a mass fraction of an amine in the amine-modified nanomaterial is from 3% to 8%.

9. A method for preparing a sealant, comprising:
mixing an amine-modified nanomaterial with a sealant base component, followed by defoaming and curing, to obtain the sealant.

10. The method according to claim 9, wherein the curing includes: precuring at 80° C. for 2 hours (hrs), curing at 100° C. and 140° C. for 3 hrs and 4 hrs respectively, and post-curing in a vacuum oven at 150° C. for 30 minutes.

11. The method according to claim 9, wherein the amine-modified nanomaterial is obtained by:
mixing a nanomaterial with a concentrated acid, and heating in a first water bath at 50-80° C. for 8-12 hrs to obtain an acid-treated nanomaterial; then, heating the acid-treated nanomaterial with SOCl₂ in a second water bath at 50-80° C. for 18-30 hrs, filtering, drying, then heating with an amine in a third water bath at 100-150° C. for 30-40 hrs, and drying, to obtain the amine-modified nanomaterial.

12. A display panel, comprising a sealant including a sealant base component; and an amine-modified nanomaterial.

13. (canceled)
